(19) United States
(12) Patent Application Publication
(10) Pub. No.: US 2005/0074516 A1
(43) Pub. Date: Apr. 7, 2005

(54) Injection molding machine

(76) Inventor: Giovanni Antonio Coscia, Varese VA (IT)

Correspondence Address: JACOBSON HOLMAN PLLC, 400 SEVENTH STREET N.W., SUITE 600, WASHINGTON, DC, 20004, US

(21) Appl. No.: 10/945,102

(22) Filed: Sep. 21, 2004

(30) Foreign Application Priority Data
Oct. 3, 2003 (IT) MI2003A 001907

(51) Int. Cl. B29C 45/50

(52) U.S. Cl. 425/574

(57) ABSTRACT

An injection molding machine comprises:
a body (12) provided with a rectilinear cavity having a first end which is open and a second end (20a) opposite to the first one in which a nozzle (21) for injection into the mould (16) is disposed;
a floating punch (15) that is slidable within the cavity in the hollow body (12) between said first and second ends to define an injection chamber (20) with said second end (20a), said punch being provided with a passage (15c) to supply a way for access to the chamber (20);
feeding means (13) adapted to be received in the first open end of the hollow body, to feed the injection chamber (20) with the material through the passage (15c) in the floating punch (15);
thrust means (14) adapted to be received in the first open end of the hollow body (12) as an alternative to the feeding means (13), to make the floating punch (15) slide towards the injection nozzle (21), thereby causing injection into the mould of the material previously fed to the chamber (20).

### BACKGROUND OF THE INVENTION

1. Field of the Invention

The present invention relates to an injection molding machine, in particular for rubber or plastic material.

2. State of the Prior Art

In the field of presses for injection molding, the injector unit for injecting the material into the mould has technical problems of great importance.

The traditional machines of the known art (those having a reciprocal screw or a screw with a piston, for example) comprise a plasticizing screw assembly adapted to feed the injection chamber with the material for the mould. These machines also comprise a non-return valve necessary to prevent return of the material from the injection chamber to the plasticizing screw assembly when the rubber injection takes place. Movements enabling closure of the valve occur due to generation of the injection pressure within the chamber, and are of an uncertain duration. This fact involves an unsatisfactory precision in metering the injection amount because the whole material of a batch is not fully injected into the mould, but part of it flows back to the plasticizing screw assembly during the closure movement of the valve.

In order to solve the problem concerning metering of the material, attempts have been made to use valves of the hydraulic type; this solution however, appears to be not very efficient, weakly reliable and subjected to quick wear. More recently molding machines have been devised that are provided with an injector unit operating in the absence of nonreturn valves and introducing the material from the same end of the chamber designed for subsequent delivery to the mould. These machines ensure a satisfactory and precise metering of the material to be injected into the mould. However, the work behavior of the injector unit is of the LIFO (Last In First Out) type, i.e. the last material portions introduced into the injector are also the first ones to come out therefrom and move to the mould. This situation is typically negative because part of the rubber remain within the injection chamber for longer periods than the rest of the material; this phenomenon can cause partial burns and lack of homogeneity in the material within the injection chamber (and therefore in the mould), which will bring about a decay in the quality of the final product.

It is a general aim of the present invention to obviate the above mentioned drawbacks by providing an injection molding machine enabling a very precise metering of the material to be injected, a continuous change of the rubber (or the plastic material) within the injector and, consequently, a satisfactory homogeneity of the material injected into the mould.

### SUMMARY OF THE INVENTION

In view of the above aim an injection molding machine has been devised, in accordance with the invention, which comprises:
a body provided with a rectilinear cavity having a first end which is open and a second end opposite to the first one, in which a nozzle for injection into the mould is disposed;
a floating punch that is slidable within the cavity in the hollow body between said first and second ends to define an injection chamber with said second end, said punch being provided with a passage to supply a way for access to the chamber;
feeding means adapted to be received in the first open end of the hollow body, to feed the injection chamber with the material through the passage in the floating punch;
thrust means adapted to be received in the first open end of the hollow body as an alternative to the feeding means, to make the floating punch slide towards the injection nozzle, thereby causing injection into the mould of the material previously fed to the chamber.

### BRIEF DESCRIPTION OF THE DRAWINGS

For better explaining the innovative principles of the present invention and the advantages it offers as compared with the known art, a possible embodiment applying these principles will be described hereinafter, by way of non-limiting example, with the aid of the accompanying drawings. In the drawings:

FIG. 1 is a view of the injector unit of an injection molding machine in accordance with the present invention;

FIG. 2 is a sectional view of part of the injector unit in a first step of the injection cycle;

FIG. 3 is a sectional view of part of the injector unit in a second step of the injection cycle;

FIG. 4 is a sectional view of part of the injector unit in a third step of the injection cycle;

FIG. 5 is a sectional view of part of the injector unit in a fourth and last step of the injection cycle.

### DETAILED DESCRIPTION OF THE INVENTION

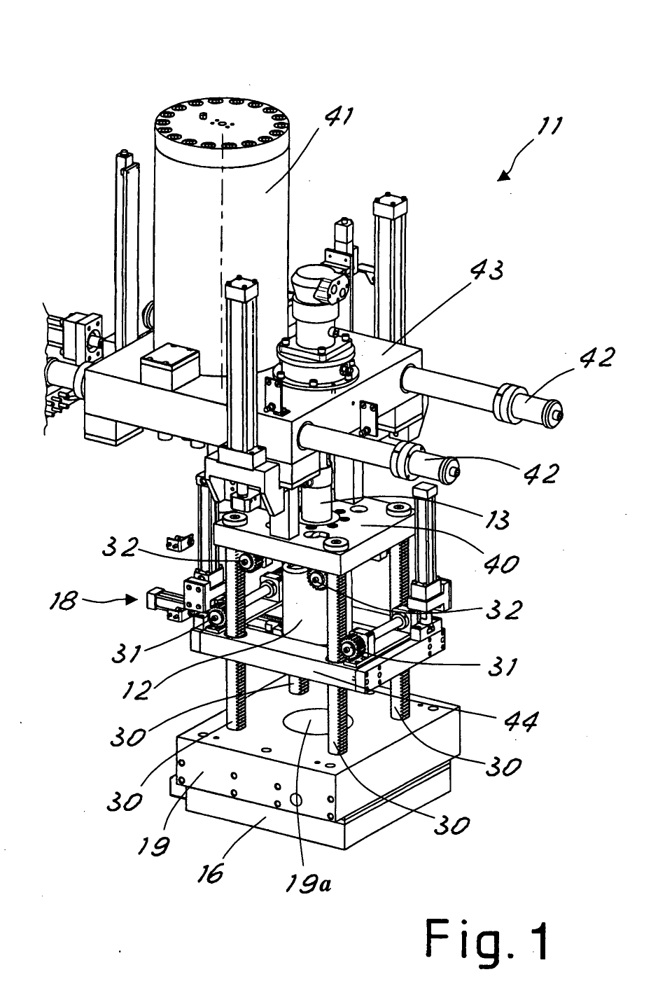

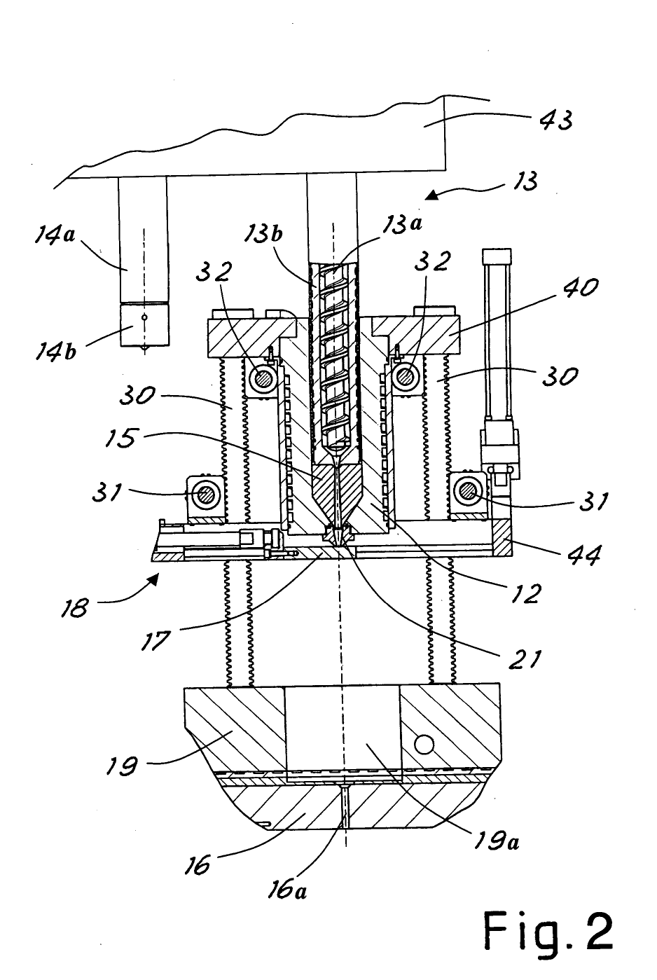

With reference to the drawings, shown in FIG. 1 is an injector unit 11 of an injection molding machine, to inject rubber for example, in accordance with a preferred embodiment of the invention. This injector unit 11 comprises an injection body 12 within which the injection chamber is located, as widely described in the following. The body 12 is fastened to a support plate 40 and can be vertically moved along the four toothed bars 30 by driving the four cogwheels 32 (only two of which are shown in FIG. 1) in rotation, said cogwheels engaging with the toothed bars 30. The support element 44, to which a counter-plate 17 and the respective horizontal movement system 18 (shown in FIG. 2) are fastened, can move in a vertical direction along the toothed bars 30 in the same manner as the support plate 40. In this case translation is carried out by setting the four cogwheels 31 (only two of which are shown in FIG. 1) in rotation, said cogwheels too being in engagement with the toothed bars 30.

Shown in FIG. 1 is also a plasticizing screw assembly 13 inserted in plate 40 and at the inside of the injection body 12. This plasticizing screw assembly 13 is fastened to a translation carriage 43. The carriage 43 is mounted on two pins 42 so that it can translate in a horizontal direction. This translation can take place when the plate 40 is at a lowered position and the plasticizing screw assembly 13 is no longer inserted in the injection body 12. When the carriage 43 has translated to the right, to the end-of-stroke position, the pusher cylinder 41, also fastened to carriage 43, is over the injection body 12. Projecting from the pusher cylinder 41 at the lower part thereof is an injection piston 14 (not shown in FIG. 1) that is designed to replace the plasticizing screw assembly 13 within the injection body 12, as widely described in the following.

Also shown still in FIG. 1 is part of the mould 16 and a block 19. This block 19 is provided with a cavity 19a designed to receive the injection body 12 when the latter is in its lowered position for injection of rubber into the mould.

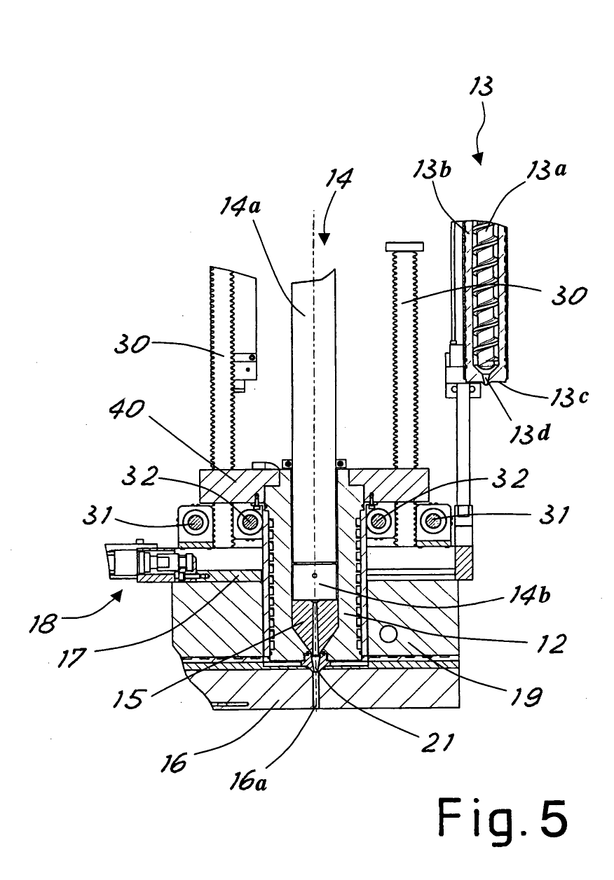

As shown in FIGS. 2 to 5, the body 12 is provided with an almost cylindrical vertical cavity within which a floating punch 15 can freely slide in a vertical direction. The floating punch 15 carries out a sealing action and defines an injection chamber 20 together with body 12; this chamber 20 has a variable volume depending on the position of the floating punch 15 relative to body 12. The floating punch 15 is provided with a hole 15c that is coaxial with the cavity of body 12 so as to form an access way to the injection chamber 20. Advantageously, in accordance with known techniques, the hole 15c is of truncated conical form and the major base thereof faces downwards. It is to be noted that the lower end 20a of the cavity of body 12 is of conical shape and the front portion 15b of the floating punch 15 is such shaped as to match the shape of said conical bottom. This front portion 15b tapers preferably with an inclination of 20° or more. Advantageously, the ratio between the longitudinal extension of the floating punch 15 and the punch diameter is included between 0.3 and 5.

Positioned at the lower end 20a of the cavity of body 12 is an injection nozzle 21. The cavity of body 12 is provided, at the upper part thereof, with an open end adapted to alternately receive the plasticizing screw assembly 13 or the thrust piston 14.

The plasticizing screw assembly 13 comprises a plasticizing screw 13a contained in a chamber formed in an outer casing 13b. This screw assembly 13 also comprises a head portion 13c such shaped as to match the shape of the rear face 15a of the floating punch 15. Formed in the middle of the head 13c is a feeding nozzle 13d adapted to engage the hole 15c of the floating punch 15. Advantageously, the outer diameter of the plasticizing screw assembly 13 is smaller than the diameter of the cylindrical cavity of body 12 by at least 0.05 mm. It is to be noted that the plasticizing screw assembly 13 is fed from top and pushes the material towards the feeding nozzle 13d due to an appropriate rotatory motion of the screw 13a.

The injection piston 14 is of cylindrical shape and is adapted to be received into the cavity of body 12, in the same manner as the plasticizing screw assembly 13. This piston 14 is made up of a rod 14a and a thrust head 14b which is also such shaped as to match the shape of the rear face 15a of the floating punch 15.

Shown in FIG. 2 is the configuration taken by the injector unit 11 at the beginning of the step of feeding the injection chamber 20. Actually, this chamber 20 has a null volume in this stage of the molding cycle, since the floating piston 15 is disposed at the bottom of the cavity of body 12. The plasticizing screw assembly 13 is inserted in the cavity and rests on the rear face 15a of the floating punch 15 by its head portion 13c. Note that the screw assembly 13 is fixed in the vertical direction and can only carry out a horizontal translation; therefore, the configuration in FIG. 2 is obtained by bringing the body 12, fastened to plate 40, to the raised position. The support 44 too, to which the counterplate 17 and the means 18 for the horizontal movement of same are fastened, is in a raised position. The counterplate 17 is such disposed as to close the injection nozzle 21. Starting from this configuration, the step of feeding the injection chamber 20 can begin. The plasticizing screw 13a is driven in rotation to push the rubber material at the inside of the screw assembly 13 into hole 15c of the floating punch 15. Simultaneously the cogwheels 31 and 32 are driven in a synchronous manner. This operation aims at causing translation of body 12 downwards while maintaining the injection nozzle 21 closed by means of the counterplate 17. During translation, the floating punch 15 remains close to the plasticizing screw-assembly 13, so that the injection chamber 20 is formed at the inside of body 12. This chamber 20 receives the rubber material fed through hole 15c. This rubber material is maintained to the correct compacting level because the descent movement of body 12 is regulated (electronically, for example) in such a manner as to oppose some resistance to entry of the rubber into the injection chamber 20.

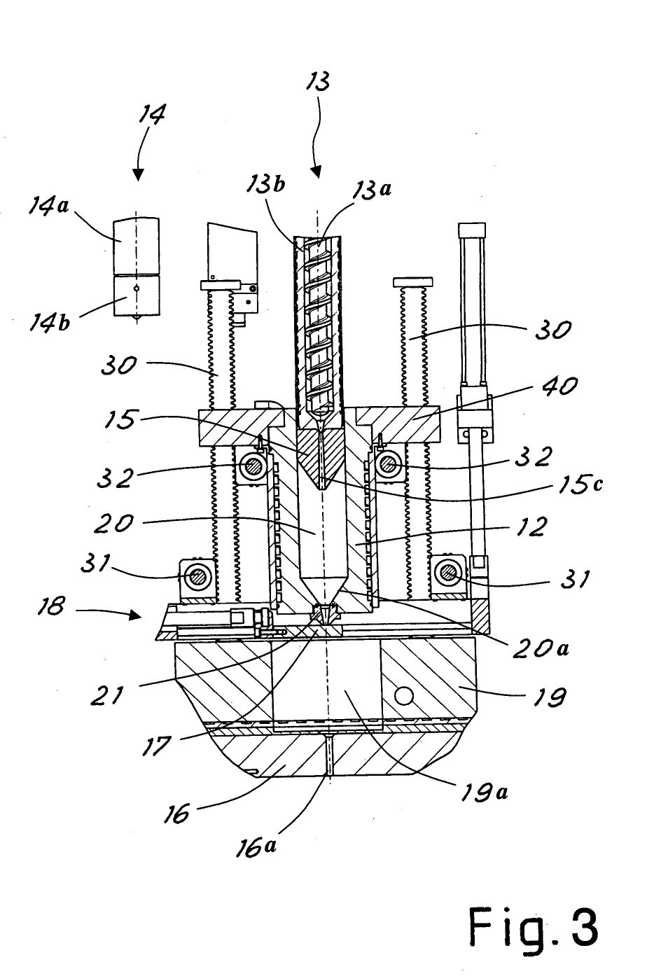

Once the desired amount of rubber has been introduced into the injection chamber 20, feeding from the screw assembly 13 is interrupted, lowering of body 12 stops and the configuration of the injector body as shown in FIG. 3 is reached. Note that body 12 can still move downwards keeping the injection nozzle 21 closed by means of the counterplate 17. In this manner the floating punch 15 can move upwards within the cavity of body 12 to release the pressure generated within the injection chamber 20. This allows the injection nozzle 21 to be opened without rubber sprinkles taking place before the true injection begins. When the inner pressure of chamber 20 has been released, nozzle 21 is opened through operation of the movement means 18 to impose a translation movement to the left to the counterplate 17.

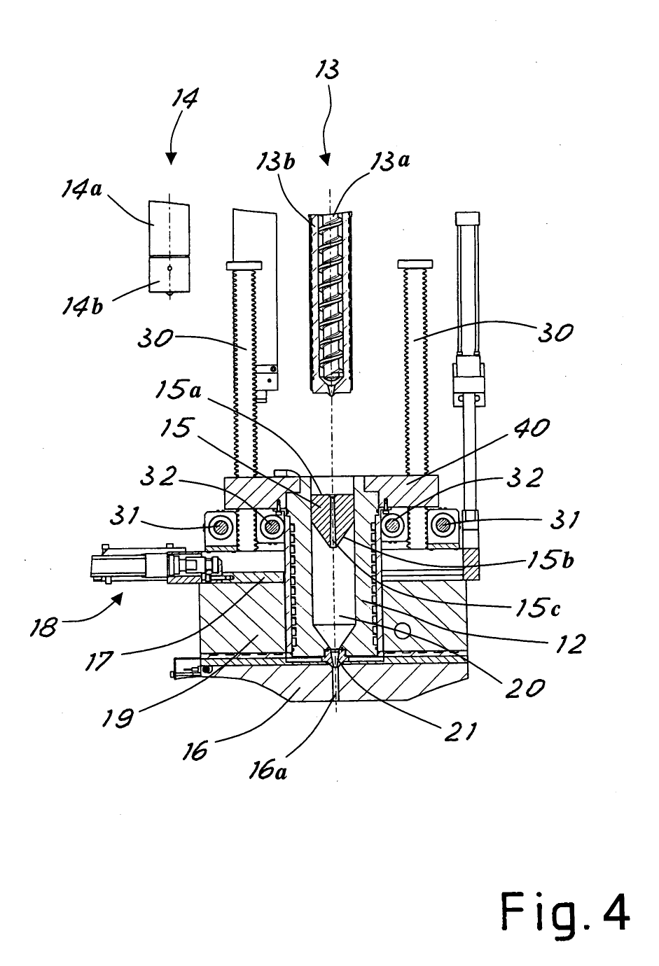

Once the counterplate 17 has been removed from the closed position, the body 12 can further move downwards, still by effect of a suitable rotation of the cogwheels 32 in engagement with bars 30. This downward translation goes on until the configuration shown in FIG. 4 is reached in which the body 12 is at the inside of the cavity 19a of block 19. In particular, the injection nozzle 21 is coupled with the injection channel 16a in mould 16. The plasticizing screw assembly 13 maintaining its position in height always fixed, is free from its engagement with the cavity of body 12 and is ready to begin its translation movement to the right to reach its rest position.

In FIGS. 2 to 4 the injection piston 14 is always shown in its rest position. Once the situation seen in FIG. 4 has been reached, this piston begins translating to the right, being rigidly connected with the plasticizing screw assembly 13. This dual translation can be obtained, as previously described, through sliding of the translation carriage 43 in a horizontal direction on the two pins 42. Once the injection piston 14 has reached a position coaxial with the injection chamber 20, said piston 14 is moved downwards by the pusher cylinder 41 so that it enters the cavity of body 12 and pushes the floating punch 15 towards the injection nozzle 21. In this manner rubber injection into mould 16 takes place, said mould having been suitably discharged and closed again to receive the new metered amount of rubber to be vulcanized.

After the above description, it is apparent that the previously listed purposes of the present invention have been reached. In particular, an injector unit has been made that allows a very precise metering of the amount of material to be injected; in fact, the particular structure with a floating punch does not include any type of non-return valve, thereby avoiding occurrence of the technical problems connected with metering that were present in the machines of the known art, due to the valve arrangement. In addition, the described injection press enables an injection with a logic of the FIFO (First In First Out) type; in fact, the injection chamber is fed from top through the floating punch, while injection takes place through a nozzle placed to the lower end of the chamber. This situation allows a high degree of homogeneity of the material to be maintained within the injection chamber and, therefore, also within the mould. It is obvious that a material with an improved homogeneity allows a final product of better quality to be obtained.

Obviously, the above description of an embodiment applying the innovative principles of the present invention is only given by way of non-limiting example and therefore must not be considered as a limitation of the scope of the patent rights herein claimed.

1. An injection molding machine, comprising:
a body provided with a rectilinear cavity having a first end which is open and a second end opposite to the first one in which a nozzle for injection into the mould is disposed;
a floating punch that is slidable within the cavity in the hollow body between said first and second ends to define an injection chamber with said second end, said punch being provided with a passage to supply a way for access to the chamber;
feeding means adapted to be received in the first open end of the hollow body, to feed the injection chamber with the material through the passage in the floating punch;
thrust means adapted to be received in the first open end of the hollow body as an alternative to the feeding means, to make the floating punch slide towards the injection nozzle, thereby causing injection into the mould of the material previously fed to the chamber.

2. An injection molding machine as claimed in claim 1, characterized in that said feeding means comprises a plasticizing screw assembly.

3. An injection molding machine as claimed in claim 1, characterized in that said thrust means comprises an injection piston.

4. An injection molding machine as claimed in claim 1, characterized in that the cavity of said body is of cylindrical elongated shape.

5. An injection molding machine as claimed in claim 1, characterized in that said body is movable in the direction of the longitudinal extension of its rectilinear cavity between a position close to the mould and a position of maximum introduction of the feeding means into said cavity.

6. An injection molding machine as claimed in claim 5, characterized in that the feeding means comprises a plasticizing screw assembly, the plasticizing screw assembly having a longitudinal axis parallel to that of the cavity of the body and being movable so as to translate, perpendicularly to its axis, alternately between a rest position and an operating position coaxial with the cavity of the body.

7. An injection molding machine as claimed in claim 5, characterized in that the thrust means comprises an injection piston, the injection piston having a longitudinal axis parallel to that of the cavity of the body and being movable so as to translate, perpendicularly to its axis, alternately between a rest position and an operating position coaxial with the cavity of the body.

8. An injection molding machine as claimed in claim 6, characterized in that the thrust means comprises an injection piston, the injection piston having a longitudinal axis parallel to that of the cavity of the body and being movable so as to translate, perpendicularly to its axis, alternately between a rest position and an operating position coaxial with the cavity of the body and the plasticizing screw assembly and the injection piston being mounted on a single translation carriage transverse to the axis of the rectilinear cavity, to be brought to their operating position in an alternate manner.

9. An injection molding machine as claimed in claim 4, characterized in that said passage in the floating punch is a hole coaxial with the cavity of the body.

10. An injection molding machine as claimed in claim 1, characterized in that the floating punch is of circular cross section and the ratio between the longitudinal extension and the diameter of same is included between 0.3 and 5.

11. An injection molding machine as claimed in claim 1, characterized in that the floating punch is provided with a front portion facing the injection chamber that is such shaped as to match the shape of said second end of the cavity of the body.

12. An injection molding machine as claimed in claim 11, characterized in that said front portion of the floating punch tapers with an inclination of 20° or more.

13. An injection molding machine as claimed in claim 2, characterized in that the plasticizing screw assembly comprises a plasticizing screw contained in a cylindrical feeding chamber formed at the inside of a casing of the plasticizing screw assembly.

14. An injection molding machine as claimed in claim 13, characterized in that the plasticizing screw assembly comprises a head portion such shaped as to match the shape of a rear face of the floating punch and a feeding nozzle formed in said head portion to feed the hole of the floating punch with material.

15. An injection molding machine as claimed in claim 4, characterized in that the feeding means comprises a plasticizing screw assembly, the plasticizing screw assembly being externally of cylindrical shape and the outer diameter of same being smaller than the inner diameter of the cavity of the body by at least 0.05 mm.

16. An injection molding machine as claimed in claim 1, characterized in that it comprises a counterplate movable to close the injection nozzle during feeding of material to the chamber.

17. An injection molding machine as claimed in claim 1, characterized in that the longitudinal extension direction of the cavity of the body is a vertical direction.
